(19) United States
(12) Patent Application Publication
(10) Pub. No.: US 2024/0103395 A1
(43) Pub. Date: Mar. 28, 2024

(54) OPTICAL SCANNING APPARATUS

(71) Applicant: KYOCERA Document Solutions Inc., Osaka (JP)

(72) Inventor: Yoshiharu KANEMATSU, Osaka (JP)

(73) Assignee: KYOCERA Document Solutions Inc., Osaka (JP)

(21) Appl. No.: 18/469,204

(22) Filed: Sep. 18, 2023

(30) Foreign Application Priority Data
Sep. 22, 2022 (JP) 2022-150946

(51) Int. Cl. G03G 15/043; G02B 26/08

(52) U.S. Cl. CPC G03G 15/043; G02B 26/0816

(57) ABSTRACT

An optical scanning apparatus includes a light source, a deflector, an optical member, and a housing. The housing has an adhesive support portion to which the optical member is bonded with adhesive applied in between and that supports the optical member. The adhesive support portion has elevated portions and a depressed portion, which are formed at a counterposed face that faces the optical member and to which the adhesive is applied, and which extend in a direction intersecting the main scanning direction. The elevated portions are disposed at opposite end parts of the counterposed face in the main scanning direction. The depressed portion is disposed between the two elevated portions with respect to the main scanning direction.

### INCORPORATION BY REFERENCE

This application is based on and claims the benefit of priority from Japanese Patent Application No. 2022-150946 filed on Sep. 22, 2022, the contents of which are hereby incorporated by reference.

### BACKGROUND

The present disclosure relates to an optical scanning apparatus.

Some image forming apparatuses of an electrophotographic type, such as copiers and printers, incorporate an optical scanning apparatus that exposes the surface of a photosensitive drum an image carrying member to light by scanning it with a light beam and that thereby forms an electrostatic latent image on the surface of the photosensitive drum. For optical scanning apparatuses, various techniques have been proposed regarding the fastening of an optical member such as a mirror to the housing of an optical scanning apparatus.

### SUMMARY

According to one aspect of the present disclosure, an optical scanning apparatus includes a light source, a deflector, an optical member, and a housing. The deflector deflects a light beam emitted from the light source. The optical member is disposed on the optical path of the light beam and extends in the main scanning direction of the light beam. The housing houses the light source, the deflector, and the optical member. The housing has an adhesive support portion to which the optical member is bonded with adhesive applied in between and that supports the optical member. The adhesive support portion has elevated portions and a depressed portion, which are formed at a counterposed face that faces the optical member and to which the adhesive is applied, and which extend in a direction intersecting the main scanning direction. The elevated portions are disposed at opposite end parts of the counterposed face in the main scanning direction. The depressed portion is disposed between the two elevated portions with respect to the main scanning direction.

### BRIEF DESCRIPTION OF THE DRAWINGS

FIG. 1 is a schematic sectional front view of an optical scanning apparatus according to one embodiment of the present disclosure.

FIG. 2 is a perspective view of the optical scanning apparatus in FIG. 1.

FIG. 3 is a front view of a turning mirror and an adhesive support portion in the optical scanning apparatus in FIG. 2.

FIG. 4 is a perspective view of the turning mirror and the adhesive support portion in the optical scanning apparatus in FIG. 2.

FIG. 5 is a perspective view of the adhesive support portion in FIG. 4.

FIG. 6 is a perspective view of the adhesive support portion in FIG. 4, with adhesive applied to it.

### DETAILED DESCRIPTION

An embodiment of the present disclosure will be described below with reference to the accompanying drawings. What is specifically disclosed herein is not meant to limit the scope of the present disclosure.

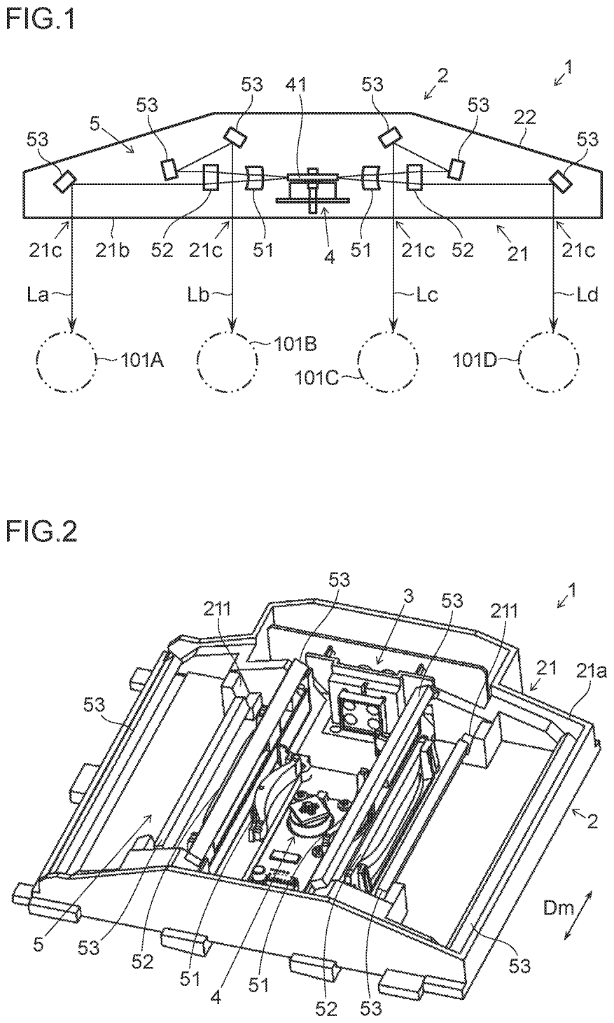

FIG. 1 is a schematic sectional front view of an optical scanning apparatus 1 according to one embodiment. FIG. 2 is a perspective view of the optical scanning apparatus in FIG. 1. In FIG. 2, a cover member 22 that covers the inner space of the optical scanning apparatus 1 is omitted from illustration. The direction indicated by an arrowed line Dm (i.e., the depth direction with respect to the plane of FIG. 1) is the main scanning direction in the optical scanning apparatus 1.

The optical scanning apparatus 1 is incorporated in an image forming apparatus (unillustrated) of an electrophotographic type such as a copier or printer, and is used to expose the surfaces of photosensitive drums 101A, 101B, 101C, and 101D to light by scanning them with a light beam and thereby form an electrostatic latent image on each of those surfaces.

As shown in FIGS. 1 and 2, the optical scanning apparatus 1 includes a housing 2, a light source 3, a polygon mirror (deflector) 4, and an optical member 5.

The housing 2 includes a housing body 21 and a cover member 22. The housing body 21 is formed in the shape of a bottomed box with an opening 21a at its top. The cover member 22 is formed substantially in the shape of a plate that closes the opening 21a of the housing body 21, and is fitted to the opening 21a to cover the inner space of the optical scanning apparatus 1.

The housing 2 houses the light source 3, the polygon mirror 4, and the optical member 5. In a bottom part 21b of the housing body 21 is disposed a window 21c, which is fitted with a light-transmitting member (unillustrated). Through the window 21c, light beams La, Lb, Lc, and Ld (described later) emitted from the light source 3 pass while traveling toward the scanned surfaces of the photosensitive drums 101A, 101B, 101C, and 101D.

The light source 3 is disposed in the housing 2, for example near a side wall of the housing 2. The light source 3 has a laser diode that is designed to emit a beam of laser light in a visible spectrum. Actually the light source 3 has four independent laser diodes that emit light beams La, Lb, Lc, and Ld to be shone onto the four photosensitive drums 101A, 101B, 101C, and 101D respectively. The light beams La, Lb, Lc, and Ld emitted from the light source 3 travel via collimator lenses and cylindrical lenses (of which none is illustrated) to strike the deflecting faces 41 around the polygon mirror 4.

The polygon mirror (deflector) 4 is disposed in the housing 2, substantially in a central part of the housing 2. The polygon mirror 4 is configured in a regular polygonal shape as seen in a plan view, and has around it a plurality of deflecting faces (reflective surfaces) 41 for reflecting light beams. The polygon mirror 4 is driven by a motor (unillustrated) to rotate about an axis perpendicular to the bottom part 21b of the housing body 21.

The light beams La, Lb, Lc, and Ld emitted from the light source 3 strike the deflecting faces 41 around the polygon mirror 4 in the direction normal to the bottom part 21b (i.e., the sub scanning direction; the up-down direction in FIG. 1), at angles slightly deviated from each other. The polygon mirror 4 deflects the light beams La, Lb, Lc, and Ld emitted from the light source 3. Specifically, while rotating, the polygon mirror 4 reflects on its deflecting faces 41 the light beams La, Lb, Lc, and Ld to direct them to the optical member 5 while deflecting them in the main scanning direction Dm.

The optical member 5 is disposed in the housing 2, on the optical paths of the light beams La, Lb, Lc, and Ld reflected from the polygon mirror 4. The optical member 5 includes, for example, a first f-theta (fθ) lens 51, a second f-theta (fθ) lens 52, and a turning mirror 53. The first f-theta lens 51, the second f-theta lens 52, and the turning mirror 53 extend in the main scanning direction Dm of the light beams La, Lb, Lc, and Ld.

The first and second f-theta lenses 51 and 52 deflect, at equal speeds in the main scanning direction Dm, the light beams La, Lb, Lc, and Ld reflected from the polygon mirror 4. The turning mirror 53 changes the optical paths of the light beams La, Lb, Lc, and Ld. Specifically, the turning mirror 53 reflects the light beams La, Lb, Lc, and Ld in predetermined directions respectively so that they pass through the window 21c and reach the surfaces of the photosensitive drums 101A, 101B, 101C, and 101D, that is, the scanned surfaces, to form images there.

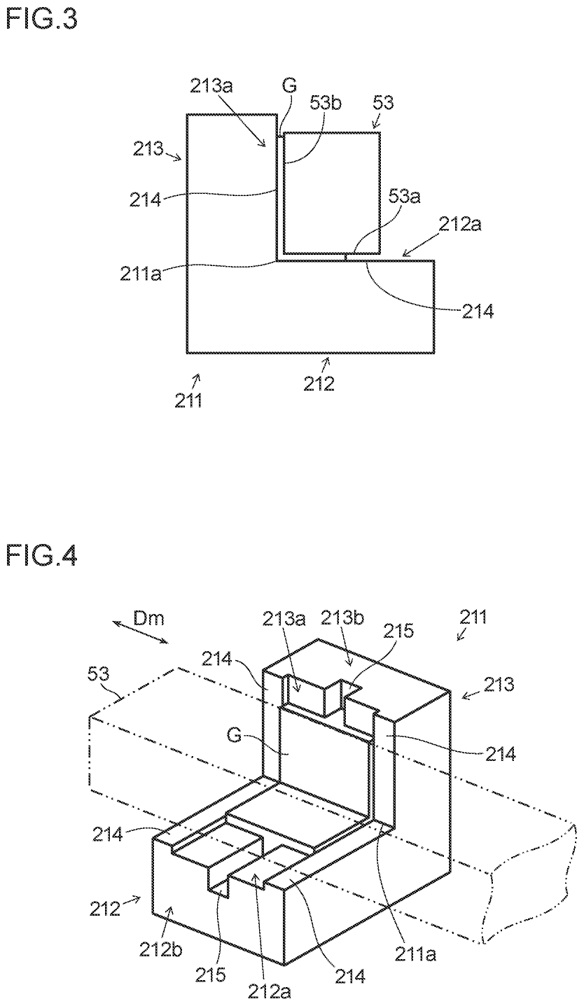

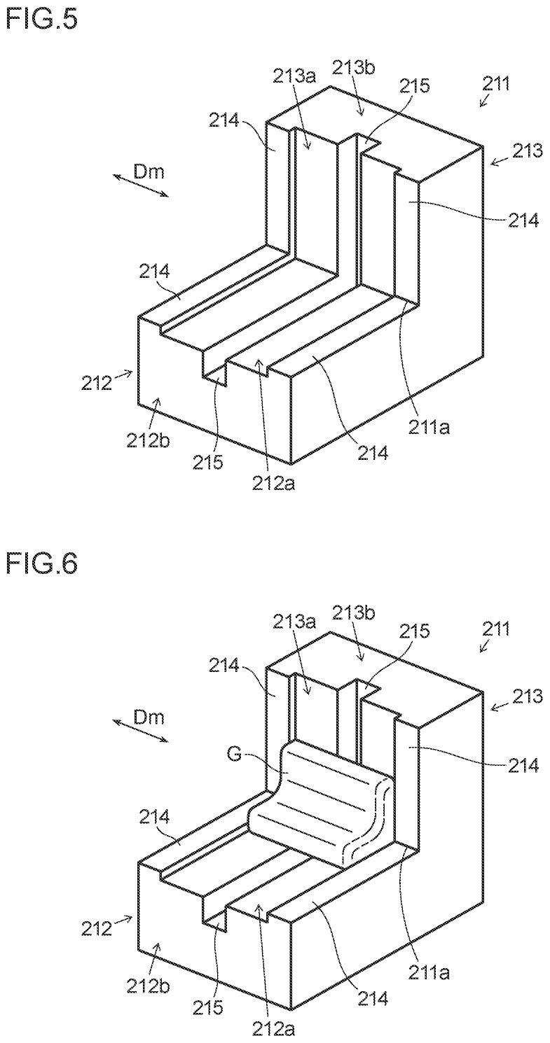

Next, the construction of the optical scanning apparatus 1 will be described in detail. FIGS. 3 and 4 are a front view and a perspective view, respectively, of the turning mirror 53 and an adhesive support portion 211 in the optical scanning apparatus 1 in FIG. 2. FIG. 5 is a perspective view of the adhesive support portion 211 in FIG. 4. FIG. 6 is a perspective view of the adhesive support portion 211 in FIG. 4, with adhesive G applied to it. In all these diagrams, the components other than the turning mirror 53 and the adhesive support portion 211 are omitted from illustration.

As shown in FIG. 2, the housing body 21 has an adhesive support portion 211. The adhesive support portion 211 is formed integrally with the housing body 21. The adhesive support portion 211 supports, for example, the turning mirror 53. While in the embodiment under discussion the adhesive support portion 211 supports, among different optical members, the turning mirror 53, it may support any other optical member instead.

Here, the turning mirror 53 is formed substantially in the shape of a rectangular parallelepiped extending in the main scanning direction Dm. The turning mirror 53 has, on one face of it extending in the main scanning direction Dm, a reflective surface for reflecting one of the light beams La, Lb, Lc, and Ld. As shown in FIGS. 3 and 4, to the adhesive support portion 211 is bonded the turning mirror 53 with adhesive G applied between them. That is, the housing 2 has the adhesive support portion 211 to which the turning mirror 53 is bonded and that supports the turning mirror 53.

The adhesive support portion 211 is formed in an L shape as seen from the main scanning direction Dm. The adhesive support portion 211 has a first support portion 212 and a second support portion 213. The first and second support portions 212 and 213 both extend in a direction intersecting the main scanning direction Dm while extending mutually different directions. For example, the first and second support portions 212 and 213 extend in directions orthogonal to each other as seen from the main scanning direction Dm (see FIG. 3).

The first support portion 212 faces a first face 53a of the turning mirror 53, and is bonded to the first face 53a with the adhesive G. The second support portion 213 faces a second face 53b, contiguous with the first face 53a, of the turning mirror 53, and is bonded to the second face 53b with the adhesive G.

As shown in FIG. 6, the adhesive G is applied to the adhesive support portion 211 before the turning mirror 53 is placed on the adhesive support portion 211. The adhesive G is applied, for example, so as to lie over from the first support portion 212 to the second support portion 213, between elevated portions 214 (described later) in the main scanning direction Dm.

The first and second support portions 212 and 213 each have elevated portions 214 and a depressed portion 215.

The elevated portions 214 and the depressed portion 215 of the first support portion 212 are formed at a counterposed face 212a that faces the first face 53a of the turning mirror 53 and to which the adhesive G is applied. The elevated portions 214 and the depressed portion 215 of the second support portion 213 are formed at a counterposed face 213a that faces the second face 53b of the turning mirror 53 and to which the adhesive G is applied.

The elevated portions 214 and the depressed portion 215 extend in a direction intersecting the main scanning direction Dm. The elevated portions 214 are disposed in opposite end parts of the counterposed faces 212a and 213a of the adhesive support portion 211. The depressed portion 215 is disposed, at each of the counterposed faces 212a and 213a, between the two elevated portions 214 with respect to the main scanning direction Dm. For example, the depressed portion 215 is disposed, at each of the counterposed faces 212a and 213a, in a middle part between the elevated portions 214 respectively in opposite end parts in the main scanning direction Dm.

The turning mirror 53 is placed on the adhesive G applied to the adhesive support portion 211, and is bonded and fastened to the adhesive support portion 211. With this configuration, the elevated portions 214 prevent the adhesive G from spreading out of the counterposed faces 212a and 213a in the main scanning direction Dm. The depressed portion 215 can store surplus adhesive G between the adhesive support portion 211 and the optical member (turning mirror 53). This prevents unintended spreading-out of the adhesive G for fastening the optical member to the adhesive support portion 211. It is thus possible to hold an adequate amount of adhesive G on the adhesive support portion 211 and to bond and fasten the optical member to the adhesive support portion 211 properly.

The optical member supported by the adhesive support portion 211 is the turning mirror 53 that changes the optical paths of the light beams La, Lb, Lc, and Ld. Thus, in association with the bonding and fastening of the turning mirror 53 to the adhesive support portion 211, it is possible to prevent unintended spreading-out of the adhesive G. It is thus possible to hold an adequate amount of adhesive G on the adhesive support portion 211 and to bond and fasten the turning mirror 53 to the adhesive support portion 211 properly.

The adhesive support portion 211 has a plurality of counterposed faces 212a and 213a that respectively face a plurality of faces (first and second faces 53a and 53b) of the turning mirror 53 that extend in the main scanning direction Dm. With this configuration, it is possible to firmly bond and fasten the turning mirror 53 to each of the counterposed faces 212a and 213a and to prevent unintended spreading-out of the adhesive G. It is possible to enhance the effect of properly bonding and fastening the turning mirror 53 to the adhesive support portion 211. That is, it is possible to enhance the positional accuracy associated with the image formation with the light beams La, Lb, Lc, and Ld on the scanned surfaces of the photosensitive drums 101A, 101B, 101C, and 101D, and to maintain accurate image formation positions for a long period.

The adhesive G is an ultraviolet-curable adhesive. With this configuration, by irradiating the adhesive G with ultraviolet rays, the optical member (turning mirror 53) can easily be bonded and fastened to the adhesive support portion 211.

The adhesive G may be a thermally curable adhesive. With this configuration, by blowing hot air onto the adhesive G, the optical member (turning mirror 53) can easily be bonded and fastened to the adhesive support portion 211.

The elevated portions 214 are elevated from the counterposed faces 212a and 213a toward the turning mirror 53. The depressed portion 215 is depressed from the counterposed faces 212a and 213a away from the turning mirror 53. The elevated portions 214 of the first support portion 212 are contiguous with the elevated portions 214 of the second support portion 213 across a junction 211a between the first and second support portions 212 and 213. The depressed portion 215 of the first support portion 212 is contiguous with the depressed portion 215 of the second support portion 213 across the junction 211a between the first and second support portions 212 and 213.

The elevated portions 214 and the depressed portion 215 extend up to an end part of each of the first and second support portions 212 and 213 in a direction intersecting the main scanning direction Dm. The depressed portion 215 is open at the respective end faces 212b and 213b of the first and second support portions 212 and 213 in a direction intersecting the main scanning direction Dm.

With the configuration described above, in a case where the adhesive G is an ultraviolet-curable or thermally curable resin, it is easy to expose the adhesive G to ultraviolet rays or hot air. It is thus possible to prevent incomplete curing of the adhesive G and to reduce the curing time.

The adhesive support portion 211 may be provided at each end part of the optical member (turning mirror 53) in the main scanning direction Dm. Or, the adhesive support portion 211 may be provided at one end part of the optical member (turning mirror 53) in the main scanning direction Dm, and a support structure using a support member such as a spring member may be provided at an another end part. That is, the adhesive support portion 211 may be provided at least at one of opposite end parts of the optical member in the main scanning direction Dm.

With the above configuration, at least at one of opposite end parts of the optical member in the main scanning direction Dm, it is possible to prevent unintended spreading-out of the adhesive G for fastening the optical member, and to bond and fasten the optical member to the adhesive support portion 211 properly.

The optical member is bonded to the adhesive support portion 211 in a state positioned relative to it based on the positions at which the light beams La, Lb, Lc, and Ld enter the optical member. With this configuration, in association with the image formation with the light beams La, Lb, Lc, and Ld on the scanned surfaces of the photosensitive drums 101A, 101B, 101C, and 101D, it is possible to determine the positions accurately. It is thus possible to achieve high-quality image formation.

The embodiment of the present disclosure described above is not meant to limit the scope of the present disclosure and allows for implementation with various modifications made without departure from the spirit of the present disclosure.

What is claimed is:

1. An optical scanning apparatus, comprising:
a light source;
a deflector that deflects a light beam emitted from the light source;
an optical member that is disposed on an optical path of the light beam and that extends in a main scanning direction of the light beam; and
a housing that houses the light source, the deflector, and the optical member;
wherein the housing has an adhesive support portion to which the optical member is bonded with adhesive applied therebetween and that supports the optical member,
the adhesive support portion has elevated portions and a depressed portion, the elevated portions and the depressed portion being formed at a counterposed face that faces the optical member and to which the adhesive is applied, the elevated portions and the depressed portion extending in a direction intersecting the main scanning direction,
the elevated portions are disposed at opposite end parts of the counterposed face in the main scanning direction, and
the depressed portion is disposed between the two elevated portions with respect to the main scanning direction.

2. The optical scanning apparatus according to claim 1, wherein
the adhesive support portion has a plurality of the counterposed faces that respectively face a plurality of faces of the optical member extending in the main scanning direction.

3. The optical scanning apparatus according to claim 1, wherein
the adhesive support portion is provided at least at one of opposite end parts of the optical member in the main scanning direction.

4. The optical scanning apparatus according to claim 1, wherein
the optical member is bonded to the adhesive support portion in a state positioned relative thereto based on a position at which the light beam enters the optical member.

5. The optical scanning apparatus according to claim 1, wherein
the adhesive is an ultraviolet-curable adhesive.

6. The optical scanning apparatus according to claim 1, wherein
the adhesive is a thermally curable adhesive.

7. The optical scanning apparatus according to claim 1, wherein
the optical member is a turning mirror that changes the optical path of the light beam.
